(19) United States
(12) Patent Application Publication
(10) Pub. No.: US 2015/0095557 A1
(43) Pub. Date: Apr. 2, 2015

(54) SEMICONDUCTOR APPARATUS AND SYSTEM

(71) Applicant: Samsung Electronics Co., Ltd., Suwon-si (KR)

(72) Inventors: Kwang-Hyun LA, Uiwang-si (KR); Woo-Seok CHANG, Seoul (KR)

(73) Assignee: SAMSUNG ELECTRONICS CO., LTD., Suwon-si (KR)

(21) Appl. No.: 14/460,483

(22) Filed: Aug. 15, 2014

(30) Foreign Application Priority Data
Sep. 27, 2013 (KR) 10-2013-0115231

(51) Int. Cl. G06F 12/02

(52) U.S. Cl. CPC G06F 12/0246
USPC 711/103

(57) ABSTRACT

A semiconductor apparatus and system are provided. The semiconductor apparatus includes a host core configured to drive at least one device drive and a solid state drive (SSD), a flash interface configured to interface with the host core and the SSD, and an internal bus configured to transmit signals between the host core and the flash interface, wherein the host core, the flash interface, and the internal bus are disposed on a single chip substrate, and the SSD is not disposed on the single chip substrate.

### CROSS-REFERENCE TO RELATED APPLICATION

This application claims priority from Korean Patent Application No. 10-2013-0115231 filed on Sep. 27, 2013 in the Korean Intellectual Property Office the contents of which are incorporated by reference in its entirety.

### BACKGROUND

1. Field

Exemplary embodiments relate to a semiconductor apparatus and system.

2. Description of the Related Art

A related art storage device using a flash memory, for example, a solid state drive (SSD), is connected to a host device and data is transmitted/received between the host device and the SSD. The SSD may be a data storage region and may include an SSD core incorporated into the SSD to control the SSD, a memory interface incorporated into the SSD, and a serial advanced technology attachment (SATA) interface for interfacing to the host device.

The SSD core incorporated into the SSD and the memory interface are hardware resources corresponding to the host core and the host memory interface constituting the host device. Since functions of the SSD core and the host core are similar to each other, hardware resources may be wasted when using duplicated structures. Further, the SATA interface for communication between the host device and the SSD has a limited speed, in comparison to an internal bus of a system on chip.

U.S. Patent Published Application No. 2012/0203955 discloses a data processing apparatus and system.

### SUMMARY

Exemplary embodiments may provide a semiconductor apparatus which can increase a data input/output processing speed while reducing power consumption.

Exemplary embodiments may also provide a semiconductor system which can increase a data input/output processing speed while reducing power consumption.

These and other objects of the exemplary embodiments will be described in or be apparent from the following description of the preferred embodiments.

According to an aspect of the exemplary embodiments, there is provided a semiconductor apparatus including a host core configured to drive at least one device drive and a solid state drive (SSD), a flash interface configured to interface with the host core and the SSD, and an internal bus configured to transmit signals between the host core and the flash interface, wherein the host core, the flash interface, and the internal bus are disposed on a single chip substrate, and the SSD is not disposed on the single chip substrate.

According to another aspect of the exemplary embodiments, there is provided a semiconductor apparatus including a host core configured to drive a solid state drive (SSD), and a flash interface configured to interface with the host core and at least one flash memory included in the SSD, wherein the host core is further configured to transmit a job instruction for the at least one flash memory to the flash interface, the flash interface is further configured to directly perform a job for the at least one flash memory according to the job instruction, and the host core and the flash interface are disposed on a single chip substrate, and the SSD is not disposed on the single chip substrate.

According to still another aspect of the exemplary embodiments, there is provided a semiconductor system including a flash memory module including at least one flash memory, a host core configured to drive the flash memory module, and a flash interface configured to interface with the host core and the flash memory module, wherein the host core and the flash interface are disposed on a single chip substrate, and the flash memory module is not disposed on the single chip substrate.

According to still another aspect of the exemplary embodiments, there is provided a semiconductor device including at least one flash memory, and a system on chip module (SoC). The SoC includes a host core configured to drive the at least one flash memory, and a flash interface configured to interface with the host core and the at least one flash memory. The flash memory is configured to be provided outside of the SoC.

### BRIEF DESCRIPTION OF THE DRAWINGS

The above and other features and advantages of the exemplary embodiments will become more apparent by describing in detail preferred embodiments thereof with reference to the attached drawings in which:

FIG. 1 is a schematic diagram illustrating a semiconductor apparatus according to an embodiment;

FIGS. 2A and 2B are schematic diagrams illustrating a host core used in the semiconductor apparatus according to an embodiment ;

FIG. 3 is a schematic diagram illustrating a host memory interface used in the semiconductor apparatus according to an embodiment;

FIG. 4 illustrates an internal logic structure of a memory device connected to a host memory interface;

FIG. 5A illustrates a data path between a host core and a flash memory in the semiconductor apparatus according to an embodiment of the present inventive concept, FIG. 5B illustrates a data path between a host core and a flash memory as a comparative embodiment, and FIG. 5C illustrates a data path between a memory device and a flash memory in a semiconductor apparatus according to an embodiment;

FIG. 6 illustrates a data read operation of a semiconductor apparatus according to an embodiment;

FIG. 7 illustrates a data write operation of a semiconductor apparatus according to an embodiment;

FIG. 8A is a schematic diagram illustrating a semiconductor system according to an embodiment of the present inventive concept and FIG. 8B is a schematic diagram illustrating a semiconductor system according to another embodiment; and

FIGS. 9 and 10 are schematic diagrams illustrating semiconductor systems according to other embodiments.

### DETAILED DESCRIPTION OF THE EMBODIMENTS

Exemplary embodiments will now be described more fully hereinafter with reference to the accompanying drawings, in which preferred embodiments are shown. Exemplary embodiments may, however, be embodied in different forms and should not be construed as limited to the embodiments set forth herein. Rather, these embodiments are provided so that this disclosure will be thorough and complete, and will fully convey the scope of the embodiments to those skilled in the art. The same reference numbers indicate the same components throughout the specification. In the attached figures, the thickness of layers and regions is exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s), as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the exemplary embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the exemplary embodiments.

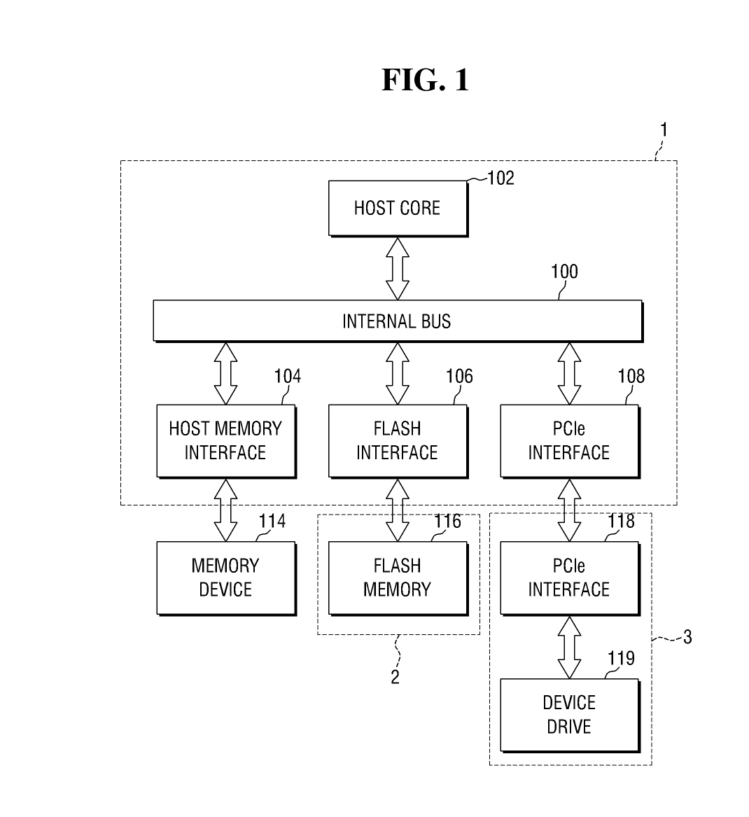

FIG. 1 is a schematic diagram illustrating a semiconductor apparatus according to an embodiment.

Referring to FIG. 1, the semiconductor apparatus 1 according to the embodiment includes an internal bus 100, a host core 102, a host memory interface 104, and a flash interface 106. In addition, the semiconductor apparatus 1 may further include a peripheral component interconnect express (PCIe) interface 108. The semiconductor apparatus 1 is mounted in a host device, for example, a portable terminal, to operate the host device. The internal bus 100, the host core 102, the host memory interface 104 and the flash interface 106, included in the semiconductor apparatus 1 according to the embodiment, may be implemented as a single system on chip (SoC). In some embodiments, the SoC may be implemented by an application processor mounted on the portable terminal.

The internal bus 100 may be a path through which signals are transmitted or data moves in the semiconductor apparatus 1. The host core 102, the host memory interface 104, the flash interface 106, and the PCIe interface 108 may be connected to each other through the internal bus 100. In some embodiments, the internal bus 100 may be configured to comply with the AXI (AMBA Advanced eXtensible Interface) protocol.

The host core 102 controls operations of various components constructed on the semiconductor apparatus 1, including the host memory interface 104, the flash interface 106, and so on. In addition, the host core 102 may control operations of the memory device 114, the SSD 2, the device drive 3, etc., connected to the host device. For example, the host core 102 may control the flash interface 106 to read data stored in the SSD 2 connected to the flash interface 106 or to write new data in the SSD 2.

The host memory interface 104 interfaces with the memory device 114 connected to the host device to transmit and data. For example, the host memory interface 104 may store the data withdrawn from the SSD 2 in a particular address of the memory device 114 or may withdraw the data stored in the particular address of the memory device 114 to transmit the withdrawn data to the device drive 3. In some embodiments, the address to access the memory device 114 may be acquired from the host core 102. In some embodiments, the memory device 114 may be an arbitrary volatile semiconductor device, such as a dynamic random access memory (DRAM) including, for example, a double data rate static DRAM (DDR SDRAM), a single data rate SDRAM (SDR SDRAM), a low power DDR SDRAM (LPDDR SDRAM), a low power SDR SDRAM (LPSDR SDRAM), or a direct rambus DRAM (RDRAM). However, exemplary embodiments are not limited thereto.

The flash interface 106 may interface to the SSD 2 connected to the host device to read data from the SSD 2 or to write data in the SSD 2. In an exemplary embodiment, the SATA interface refers to all versions of SATA, all SATA revisions, and all interfaces based on SATA. In some embodiments, the SSD 2 does not include a computation core, a memory interface, or an SATA interface inherent in the SSD 2. However, the SSD 2 includes only circuits composed of at least one flash memory 116 (for example, a plurality of NAND flash memories). In particular, the flash interface 106 used in the semiconductor apparatus 1 according to the embodiment may be directly connected to the internal bus 102 and the at least one flash memory 116, and the flow of data between the flash interface 106 and other components constituting the semiconductor apparatus 1 is achieved through only the internal bus demonstrating a markedly high data transfer rate compared to that of the SATA interface. Accordingly, the input and output processing time of the SSD 2 can be reduced. In addition, since it is not necessary for the SSD 2 to have a separate built-in computation core, a separate built-in memory interface and a separate built-in SATA interface, the manufacturing cost of the SSD 2 can be reduced and power consumption required by the SSD 2 can be reduced.

The PCIe interface 108 may interface to the device drive 3 connected to the host device. The device drive 3 may include a PCIe interface 118 to interface to the semiconductor apparatus 1 and a device drive circuit 119 implementing the function of the device drive 3. In some embodiments, the device drive 3 may be a graphic card or a storage device, such as a hard disk drive (HDD) or a solid state drive (SSD), supporting the PCIe interface 118.

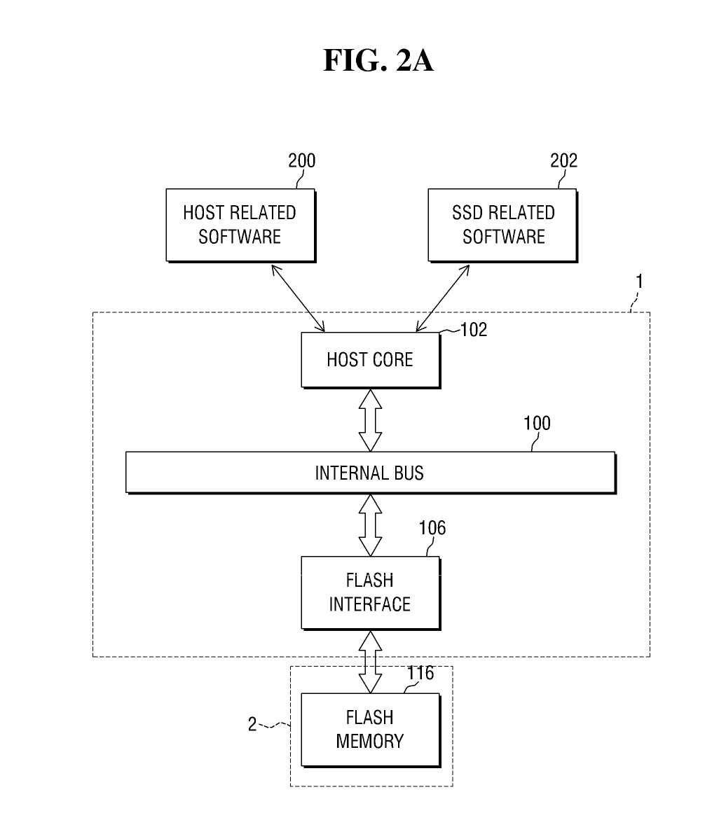

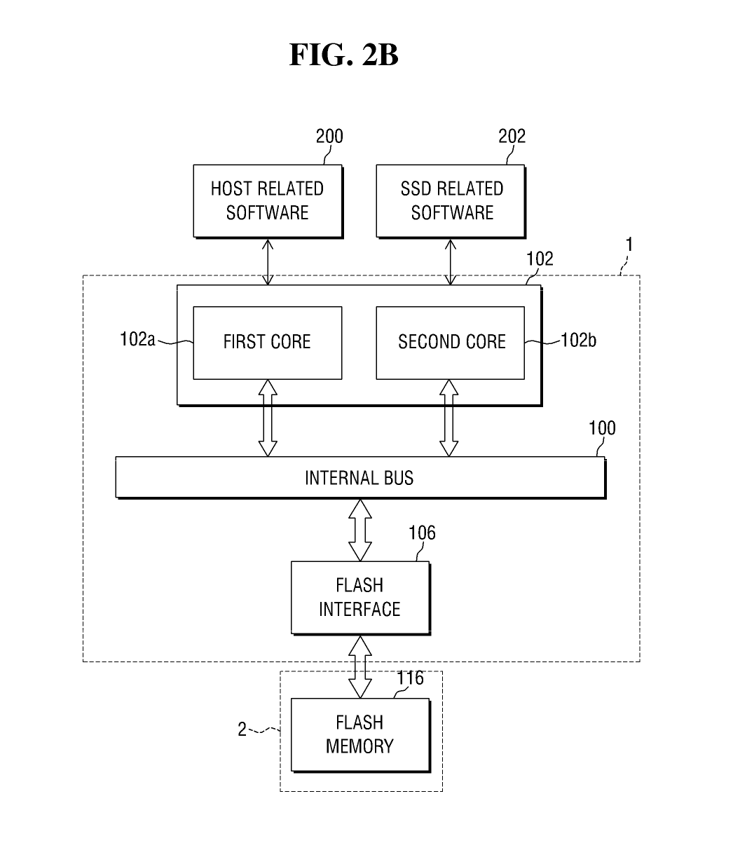

FIGS. 2A and 2B are schematic diagrams illustrating a host core used in the semiconductor apparatus according to an embodiment.

Referring to FIG. 2A, the host core 102 used in the semiconductor apparatus 1 according to the embodiment is shared by the host device and the SSD 2. In detail, the host core 102 may execute both host related software 200 and SSD related software 202. The host related software 200 may include, for example, user application software executed by the host device or system software executed by the host device. The SSD related software 202 may include, for example, software for controlling the SSD 2 or software for processing the data stored in the SSD 2. In some embodiments, the host core 102 may execute the host related software 200 and the SSD related software 202 concurrently or sequentially. Further, referring to FIG. 2B, the host core 102 used in the semiconductor apparatus according to the embodiment may include a first core 102a for executing the host related software 200 and a second core 102b for executing the SSD related software 202.

In other words, since the host core 102 used in the semiconductor apparatus according to the embodiment is shared by the host device and the SSD 2 and processes both of the host related software 200 and the SSD related software 202, it is not necessary for the SSD 2 to have a separate core inherent in the SSD 2. Accordingly, the manufacturing cost of the SSD 2 can be reduced and power consumption required by the SSD 2 can be reduced.

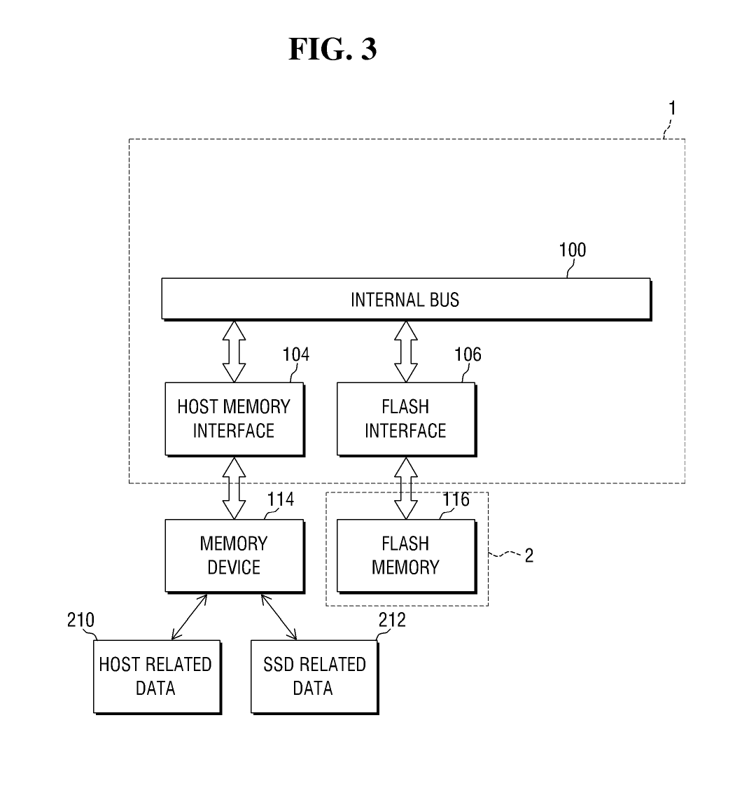

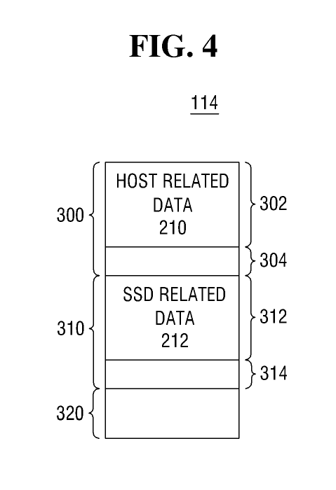

FIG. 3 is a schematic diagram illustrating a host memory interface used in the semiconductor apparatus according to an embodiment and FIG. 4 illustrates an internal logic structure of a memory connected to a host memory interface.

Referring to FIG. 3, the host memory interface 104 used in the semiconductor apparatus according to the embodiment is shared by the host device and the host device and the SSD 2. In detail, the host memory interface 104 may read or write both of host device related data 210 and SSD related data 212. The host device related data 210 may include, for example, data used by a user application executed in the host device or data used by system software executed in the host device. The SSD related data 212 may include, for example, data read from the SSD 2 or data to be written in the SSD 2.

Referring to FIG. 4, in some embodiments, the internal logic structure of the memory device 114 may include a first memory region 300, a second memory region 310, and a third memory region 320. The first memory region 300 may include host related data 302, and the second memory region 310 may include SSD related data 312. The first memory region 300 and the second memory region 310 may further include empty spaces 304 and 314, respectively. The third memory region 320 may be a region used in a system of the host device.

As described above, since the memory device 114 used in the semiconductor apparatus 1 according to the embodiment is shared by the host device and the SSD 2 to store both the host related data 210 and the SSD related data 212 in the memory device 114, it is not necessary for the SSD 2 to have a separate built-in memory interface and a separately built-in memory device inherent in the SSD 2. Accordingly, the manufacturing cost of the SSD 2 can be reduced and power consumption required by the SSD 2 can be reduced.

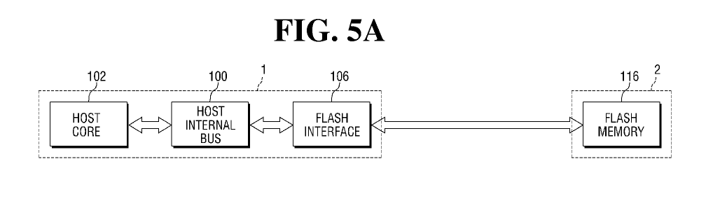

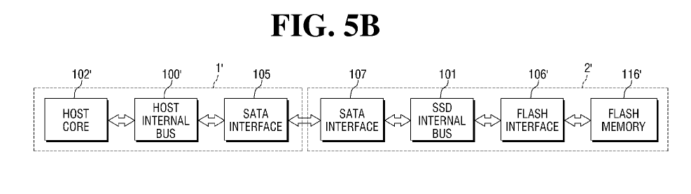

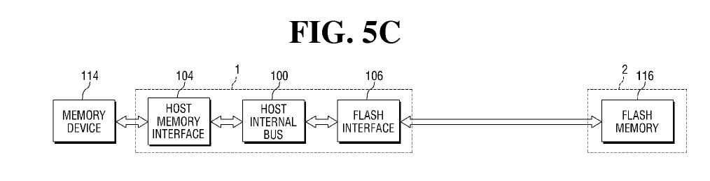

A data path between a semiconductor apparatus according to the embodiment and a flash memory will be described with reference to FIGS. 5A to 5C.

FIG. 5A illustrates a data path between a host core and a flash memory in the semiconductor apparatus according to an embodiment and FIG. 5B illustrates a data path between a host core and a flash memory as a comparative embodiment.

Referring to FIG. 5A, data generated in the host core 102, for example, a job instruction for the SSD 2, may be directly transferred to the flash interface 106 through the host internal bus 100. Thereafter, the flash interface 106 may transmit and receive the data to and from the flash memory 116 of the SSD 2 according to the received job instruction. Meanwhile, referring to FIG. 5B, after a job instruction for the SSD 2′ generated in a host core 102′ of a SoC 1′ reaches the SATA interface 105 through a host internal bus 100′, it may be transferred to a flash interface 106′ through an SATA interface 107 and a storage internal bus 101 incorporated into the SSD 2′. Thereafter, the flash interface 106′ may transmit and receive data to and from a flash memory 116′ of the SSD 2′ according to the received job instruction.

Accordingly, since the flow of data between the host core 102 and the flash interface 106 in the semiconductor apparatus 1 is achieved only through the internal bus with a high data transfer rate, compared to that of the SATA interface, the input/output processing time of the SSD 2 can be reduced.

FIG. 5C illustrates a data path between a memory device and a flash memory in the semiconductor apparatus according to an embodiment.

Referring to FIG. 5C, the data read from, for example, the SSD 2, is transferred to the flash interface 106 under the control of the host core 102, and the flash interface 106 may transfer the data directly to the host memory interface 104 through the host internal bus 100. Thereafter, the memory device 114 may receive the data from the host memory interface 104 and then store the same. In addition, the data stored in, for example, the memory device 114 to then be written in the SSD 2, is transferred to the host memory interface 104 under the control of the host core 102, and the data may be directly transferred to the flash interface 106 through the host internal bus 100.

Accordingly, since the flow of data between the host memory interface 104 and the flash interface 106 in the semiconductor apparatus 1 is achieved only through the internal bus with a high data transfer rate, compared to that of the SATA interface, the input and output processing time of the SSD 2 can be reduced.

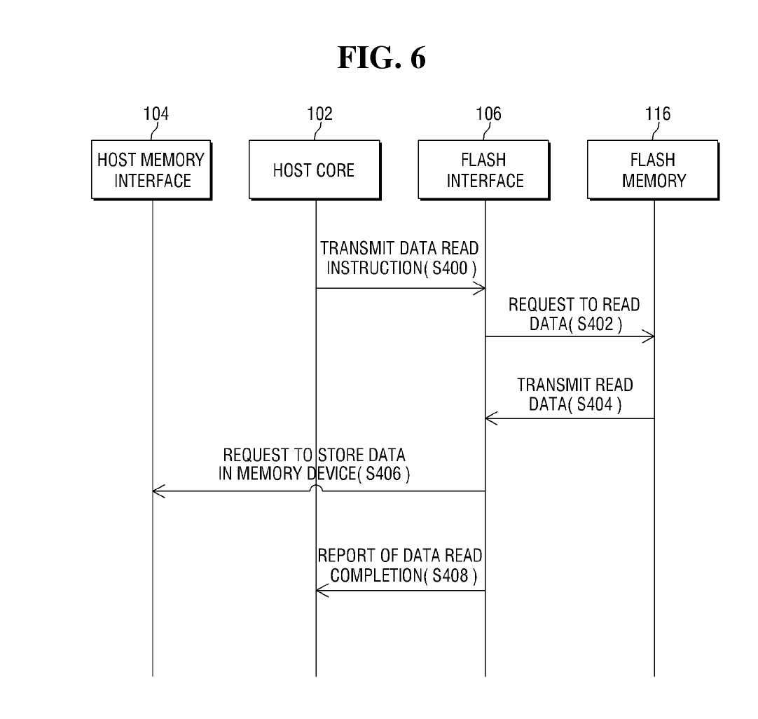

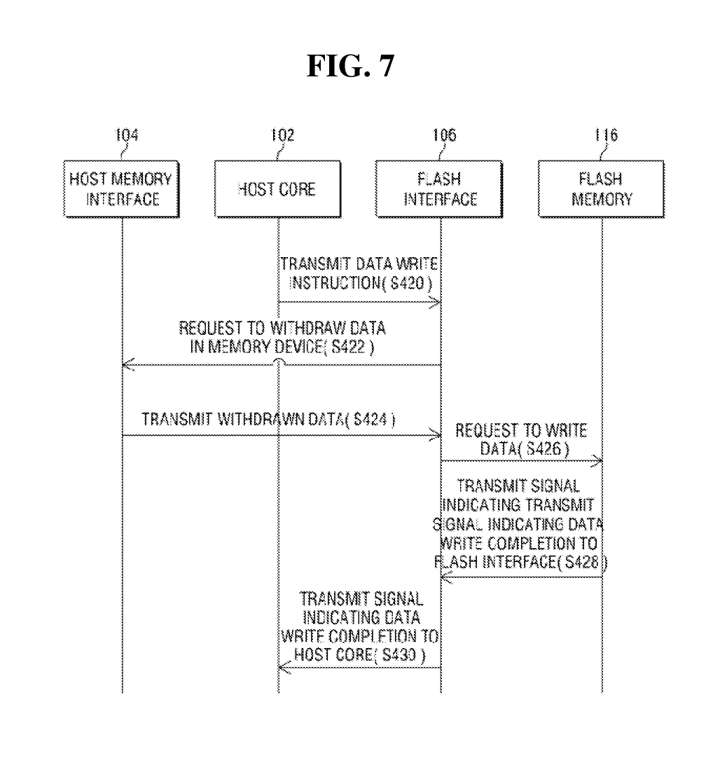

Hereinafter, operations related to data of a semiconductor apparatus according to an embodiment will be described with reference to FIGS. 6 and 7.

FIG. 6 illustrates a data read operation of a semiconductor apparatus according to an embodiment and FIG. 7 illustrates a data write operation of a semiconductor apparatus according to an embodiment.

The semiconductor apparatus 1 may include a flash interface 106 for interfacing with at least one flash memory 116, and a host core 102 transmitting a data read instruction or a data write instruction for the at least one flash memory 116 to the flash interface 106. In addition, the semiconductor apparatus 1 may further include a host memory interface 104 for interfacing with a memory device 114. The flash interface 106 and the host core 102 may be connected to each other through the internal bus 100 of the semiconductor apparatus 1. Further, the flash interface 106 and the host memory interface 104 may be connected to each other through the internal bus 100 of the semiconductor apparatus 1.

Referring to FIG. 6, the host core 102 may transfer the data read instruction to the flash interface 106 (S400). The flash interface 106 may directly read the data stored in the at least one flash memory 106 according to the received data read instruction. Further, the flash interface 106 may transmit a data read request to the at least one flash memory 116 (S402). After receiving the data read request, the flash memory 116 may read and transmit the data to the flash interface 106 (S404). Next, the flash interface 106 may request to store the directly read data in the memory device 114 according to the data read instruction through the host memory interface 104 (S406), and may transmit to the host core 102 a signal indicating that the data read operation is completed (S408).

Referring to FIG. 7, the host core 102 may transmit the data write instruction to the flash interface 106 (S420). The flash interface 106 may make a request to withdraw data to be directly written from the memory device 114 through the host memory interface 104 according to the received data write instruction (S422). After receiving the request, the host memory interface 104 may withdraw the data from the memory device 114 and may transmit the withdrawn data to the flash interface 106 (S424). Next, the flash interface 106 may directly write the data in one or more of the flash memory 106. Further, the flash interface 106 may transmit a request to write data to the one or more of the flash memory 106 (S426). After receiving the request, the flash memory 106 may write the data and may transmit to the flash interface 106 a signal indicating that a data write operation has been completed (S428). Thereafter, the flash interface 106 may transmit to the host core 102 the signal indicating that the data write operation has been completed (S430).

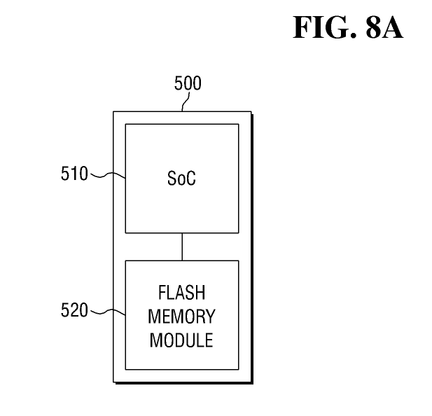

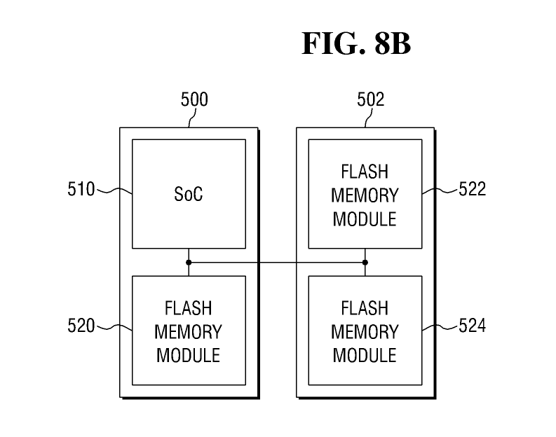

FIG. 8A is a schematic diagram illustrating a semiconductor system according to an embodiment and FIG. 8B is a schematic diagram illustrating a semiconductor system according to another embodiment.

Referring to FIG. 8A, the semiconductor system according to the embodiment may include a flash memory module 520 including one or more flash memories 116 and a SoC 510 including a flash interface 106 for interfacing with the flash memory module 520. The flash interface 106 may be directly connected to the flash memory module 520. In the semiconductor system according to the embodiment, the SoC 510 and the flash memory module 520 may be mounted on the same and one substrate 500, but aspects of the exemplary embodiments are not limited thereto. The SoC 510 and the flash memory module 520 may be mounted on different substrates. In some embodiments, the flash memory module 520 may include a plurality of NAND flash memories, but aspects are not limited thereto.

Referring to FIG. 8B, the semiconductor system according to the embodiment may include a substrate 500 on which the flash memory module 520 and the SoC 510 including the flash interface 106 for interfacing with the flash memory module 520 are mounted, and a substrate 502 on which two flash memory modules 522 and 524 are mounted. The three flash modules 520, 522, and 524 may be all connected to the flash interface 106. Accordingly, in the manufacture of a flash storage semiconductor system, since flash memory modules connected to the semiconductor apparatus 1 can be freely arranged, a large-capacity flash memory having a less spatial restriction (for example, standardized size and shape of an SSD) can be implemented.

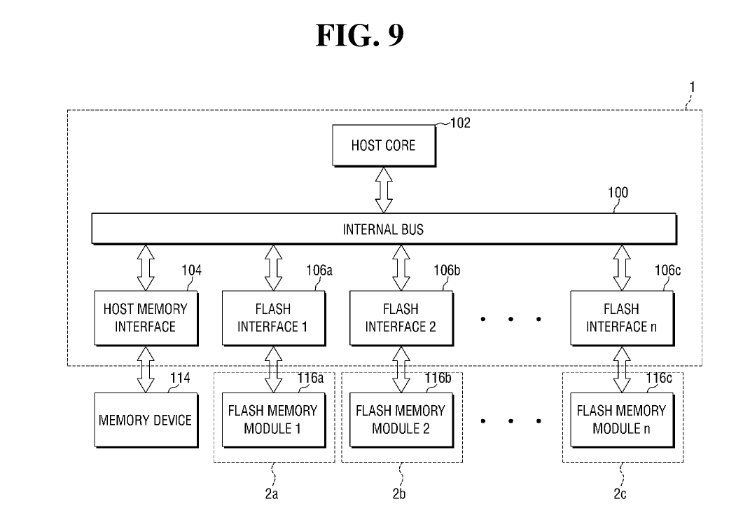

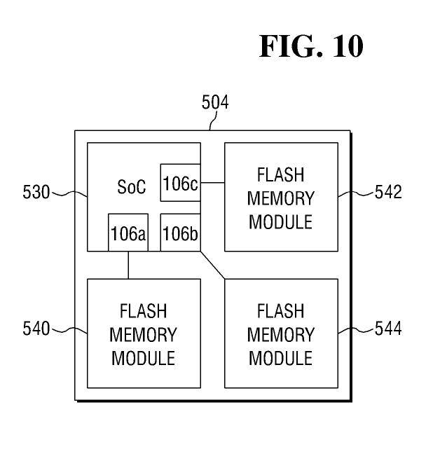

FIGS. 9 and 10 are schematic diagrams illustrating semiconductor systems according to other embodiments.

Referring to FIG. 9, the semiconductor system according to still another embodiment may include an internal bus 100, a host core 102, a host memory interface 104 and a plurality of flash interfaces 106a, 106b, and 106c. The host core 102, the host memory interface 104, and the plurality of flash interfaces 106a, 106b and 106c may be connected to each other through the internal bus 100. In some embodiments, the internal bus 100 may be configured to comply with the AXI (AMBA Advanced eXtensible Interface) protocol. The flash interfaces 106a, 106b and 106c may interface to SSDs 2a, 2b and 2c connected to a host device to read data from the SSDs 2a, 2b and 2c, or to write data in the SSDs 2a, 2b and 2c. In some embodiments, the SSDs 2a, 2b and 2c may not include an operation core, a memory interface, an SATA interface, etc., inherent in the SSDs 2a, 2b and 2c, but may include only circuits including one or more flash memories 116a, 116b, and 116c.

Referring to FIG. 10, the semiconductor system according to still another embodiment may include flash memory modules 540, 542, and 544 each including one or more flash memories 116, and SoC 530, including flash interfaces 106a, 106b and 106c for interfacing to the flash memory modules 540, 542 and 544. The flash interfaces 106a, 106b, and 106c may be directly connected to the flash memory modules 540, 542 and 544, respectively. The SoC 530 and the flash modules 540, 542, and 544 are all mounted on one substrate 504, but aspects are not limited thereto. Similar to FIG. 8B, some flash modules 542 and 544 may be mounted on separate substrates. Accordingly, in the manufacture of a flash storage semiconductor system, since the flash memory modules connected to the semiconductor apparatus 1 are freely arranged, a large-capacity flash memory having a less spatial restriction (for example, standardized size and shape of an SSD) can be implemented.

The flash interface 106 used in the semiconductor apparatus 1 according to various embodiments may be directly connected to the internal bus 100 and the one or more flash memories 116. The flow of data between the flash interface 106 and other components constituting the semiconductor apparatus 1 is achieved through only the internal bus demonstrating a markedly high data transfer rate compared to that of the SATA interface. Accordingly, the input and output processing time of the SSD 2 can be remarkably reduced. In addition, since it is not necessary for the SSD 2 to have a separate built-in SATA interface, the manufacturing cost of the SSD 2 can be reduced and power consumption required by the SSD 2 can be reduced.

In addition, since the host core 102 and the host memory interface 104 used in the semiconductor apparatus 1 according to the embodiment are shared by the host device and the SSD 2, it is not necessary for the SSD 2 to have a core and a memory interface inherent in the SSD 2. Accordingly, the manufacturing cost of the SSD 2 can be reduced and power consumption required by the SSD 2 can be reduced.

Further, in the manufacture of a flash storage semiconductor system, since the flash memory modules connected to the semiconductor apparatus 1 are freely arranged, a large-capacity flash memory having a less spatial restriction (for example, standardized size and shape of an SSD) can be implemented.

The semiconductor system according to the embodiment may comprise or be incorporated in a computer, a portable computer, an ultra mobile personal computer (UMPC), a work station, a net-book, a personal digital assistant (PDA), a portable computer, a web tablet, a wireless phone, a mobile phone, a smart phone, an e-book, a portable multimedia player (PMP), a potable game console, a navigation device, a black box, a digital camera, a 3-dimensional (3D) television, a digital audio recorder, a digital audio player, a digital picture recorder, a digital picture player, digital video recorder, a digital video player, a device capable of transmitting and receiving information in wireless environments, one of various electronic devices constituting a home network, one of various electronic devices constituting a computer network, one of various electronic devices constituting a telematics network, RFID devices, or embedded systems.

While the exemplary embodiments have been particularly shown and described with reference to exemplary embodiments thereof, it will be understood by those of ordinary skill in the art that various changes in form and details may be made therein without departing from the spirit and scope of the exemplary embodiments as defined by the following claims. It is therefore desired that the present embodiments be considered in all respects as illustrative and not restrictive, reference being made to the appended claims rather than the foregoing description to indicate the scope of the exemplary embodiments.

What is claimed is:

1. A semiconductor apparatus comprising:
a host core configured to drive at least one device drive and a solid state drive (SSD);
a flash interface configured to interface with the host core and the SSD; and
an internal bus configured to transmit signals between the host core and the flash interface,
wherein the host core, the flash interface, and the internal bus are disposed on a single chip substrate, and
wherein the SSD is not disposed on the single chip substrate.

2. The semiconductor apparatus of claim 1, wherein the host core is further configured to execute host related software and SSD related software.

3. The semiconductor apparatus of claim 2, wherein the host core comprises a first core which is configured to execute the host related software and a second core which is configured to execute the SSD related software.

4. The semiconductor apparatus of claim 2, further comprising a host memory interface connected to the internal bus for interfacing with a memory device,
wherein the host memory interface is configured to be shared by the host device and the SSD.

5. The semiconductor apparatus of claim 1, wherein the SSD does not comprise a serial advanced technology attachment (SATA) interface.

6. The semiconductor apparatus of claim 1, further comprising a peripheral component interconnect express (PCIe) interface connected to the internal bus for interfacing with the at least one device drive.

7. A semiconductor apparatus comprising:
a host core configured to drive a solid state drive (SSD); and
a flash interface configured to interface with the host core and at least one flash memory included in the SSD,
wherein the host core is further configured to transmit a job instruction for the at least one flash memory to the flash interface,
wherein the flash interface is further configured to directly perform a job for the at least one flash memory according to the job instruction,
wherein the host core and the flash interface are disposed on a single chip substrate, and
wherein the SSD is not disposed on the single chip substrate.

8. The semiconductor apparatus of claim 7, wherein the job instruction comprises a data read instruction for the at least one flash memory, and
wherein the flash interface is further configured to directly read data stored in the at least one flash memory according to the data read instruction.

9. The semiconductor apparatus of claim 7, wherein the job instruction comprises a data write instruction for the at least one flash memory, and
wherein the flash interface is further configured to directly write data in the at least one flash memory according to the data write instruction.

10. The semiconductor apparatus of claim 7, wherein the host core and the flash interface are connected to each other through an internal bus of the single chip substrate.

11. The semiconductor apparatus of claim 8, further comprising a host memory interface configured to interface with a memory device,
wherein the host memory interface is further configured to store the data directly read from the at least one flash memory by the flash interface according to the data read instruction in the memory device.

12. The semiconductor apparatus of claim 9, further comprising a host memory interface configured to interface with a memory device,
wherein the host memory interface is further configured to withdraw the data to be written in the at least one flash memory by the flash interface according to the data write instruction in the memory device.

13. A semiconductor system comprising:
a flash memory module comprising at least one flash memory;
a host core configured to drive the flash memory module; and
a flash interface configured to interface with the host core and the flash memory module,
wherein the host core and the flash interface are disposed on a single chip substrate, and
wherein the flash memory is not disposed on the single chip substrate.

14. The semiconductor system of claim 13, wherein the flash memory module comprises a first flash memory module formed on a first substrate and a second flash memory module formed on a second substrate, and
wherein the first flash memory module and the second flash memory module are connected to the flash interface.

15. The semiconductor system of claim 13, wherein the flash module comprises a plurality of flash modules which are different from each other, and
wherein the flash interface comprises a plurality of flash interfaces configured to interface with the plurality of flash modules, respectively.

16. The semiconductor apparatus of claim 1, wherein the host core, the flash interface, and the internal bus are implemented by a system on chip (SoC) which comprises the single chip substrate.

17. The semiconductor apparatus of claim 7, wherein the host core and the flash interface are implemented by a system on chip (SoC) which comprises the single chip substrate.

18. The semiconductor system of claim 13, wherein the host core and the flash interface are implemented by a system on chip (SoC) which comprises the single chip substrate.

19. A semiconductor device comprising:
at least one flash memory; and
a system on chip module (SoC), wherein the SoC comprises:
a host core configured to drive the at least one flash memory; and
a flash interface configured to interface with the host core and the at least one flash memory,
wherein the at least one flash memory is configured to be provided outside of the SoC.

20. The semiconductor device of claim 19, wherein the at least one flash memory does not comprise a serial advanced technology attachment (SATA) interface.
